(19) United States
(12) Patent Application Publication
(10) Pub. No.: US 2008/0271455 A1
(43) Pub. Date: Nov. 6, 2008

(54) Hybrid/cryo power chamber

(76) Inventor: Daniel J. Karpf, Ventura, CA (US)

Correspondence Address: Daniel J. Karpf, 385 Rodgers St., Ventura, CA, 93003, US

(21) Appl. No.: 12/070,596

(22) Filed: Feb. 19, 2008

Related U.S. Application Data
(60) Provisional application No. 60/902,581, filed on Feb. 20, 2007.

(51) Int. Cl. F01K 25/00; F03C 5/00; F01B 29/10

(52) U.S. Cl. 60/671; 60/530

(57) ABSTRACT

A Power Chamber that effectively and rapidly mixes within itself the heated air and combustion products from burning of a heat producing fuel with the injected and atomized spray of a “liquid cryogenic fuel”. This regulated and efficiently balanced mixing causes rapid expansion of the cryogenic fluid within the Power Chamber which creates rapid pressure build-up. The excess pressure that is built-up over the threshold point of the minimum operating pressure within the power chamber is channeled, via the mechanism of a door or a gate or a valve, through the Pressure Delivery Channel and made available for use to create motive power or some other kind of useful work.

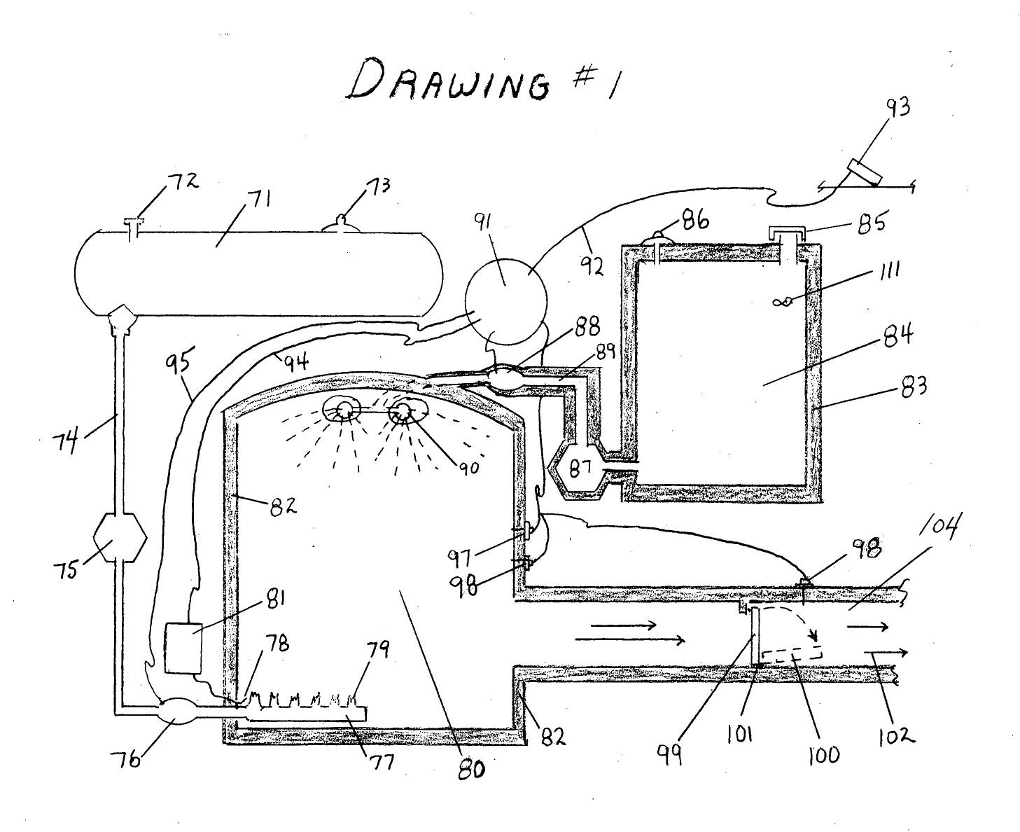

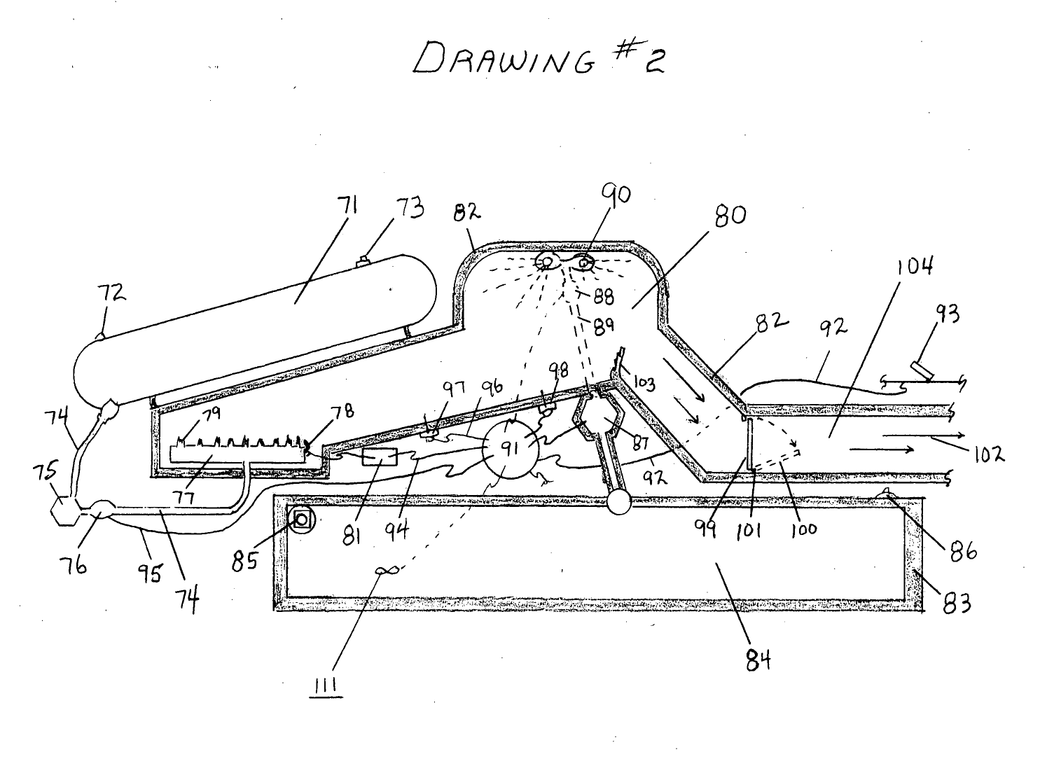

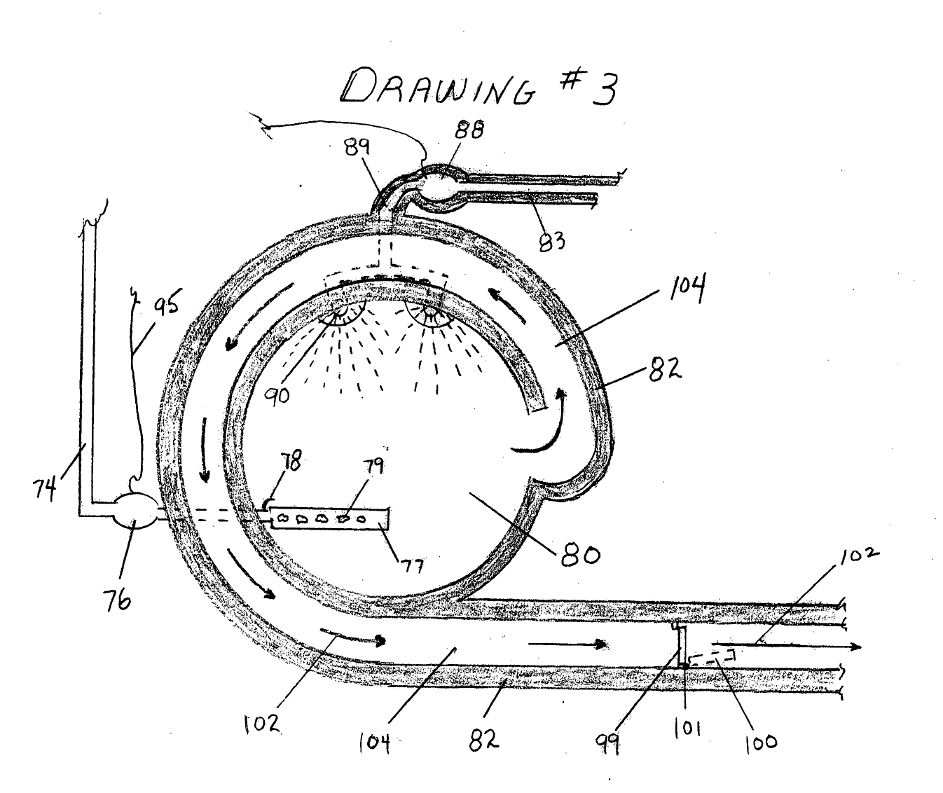

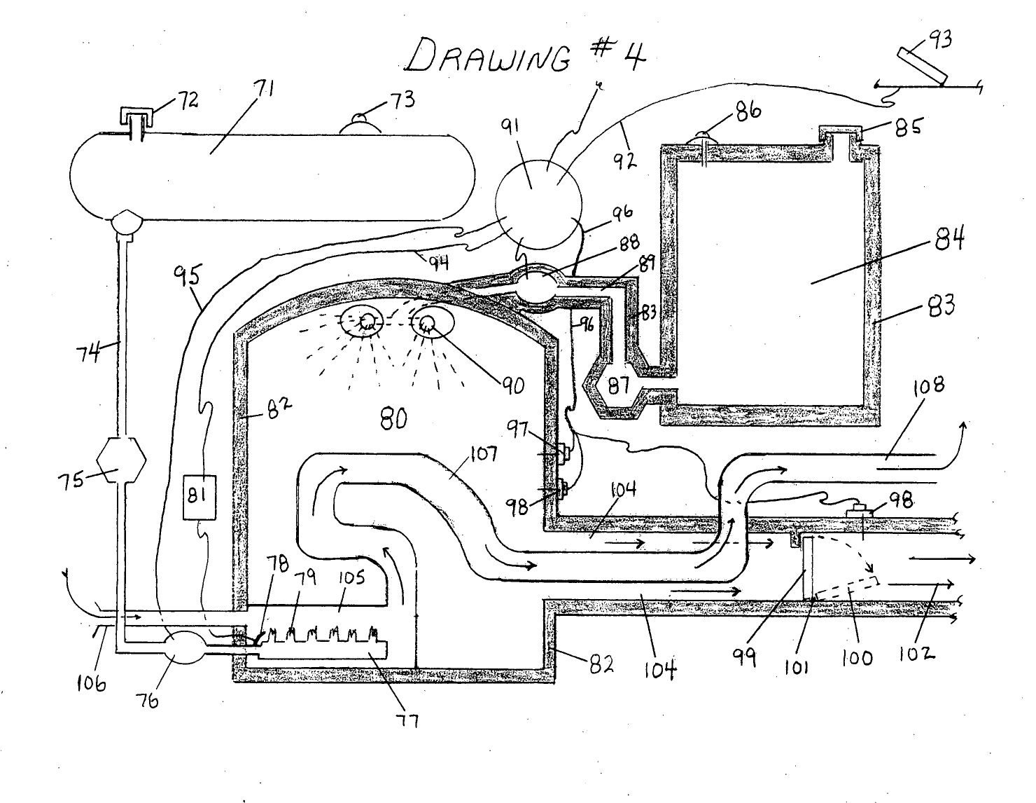

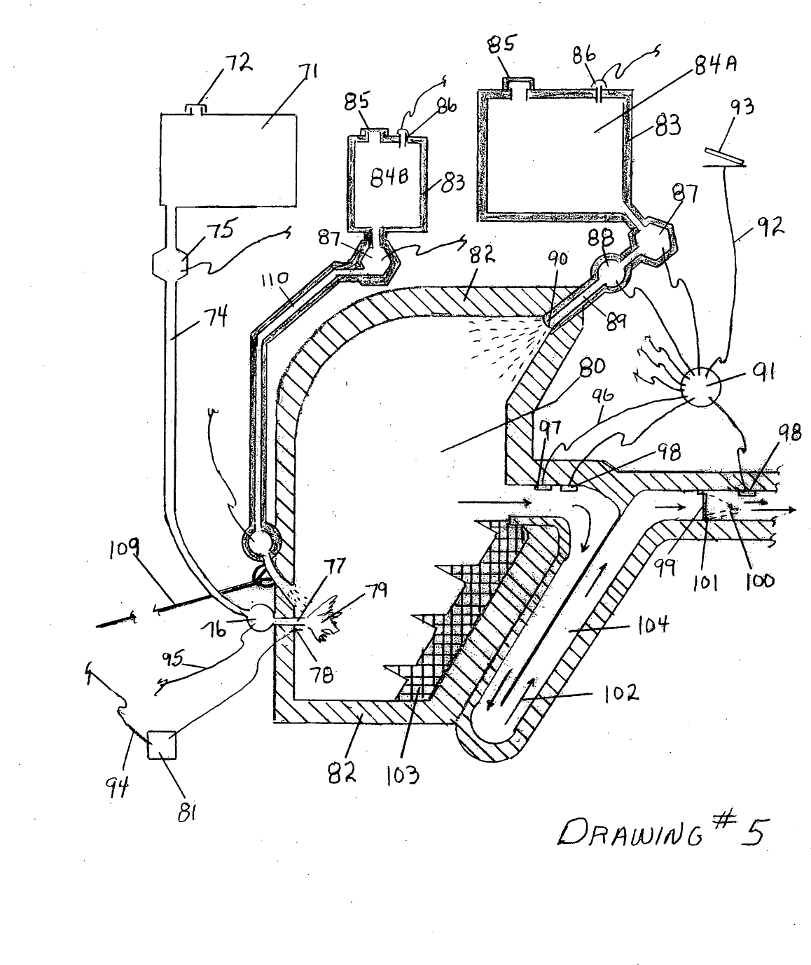

This Application claims benefit of 60/902,581 Feb. 20, 2007 (Provisional Patent Application)

### FEDERALLY SPONSORED RESEARCH

None/Not Applicable

### SEQUENCE LISTING OR PROGRAM

None/Not Applicable

### BACKGROUND

1. Field Of The Invention

This invention relates to significant improvements in the efficient utilization of the expansion power of cryogenic fluids as one of the primary “fuels” in an apparatus that produces high pressure air (or high pressure nitrogen gas). This high pressure air or nitrogen gas can be utilized in conjunction with many different kinds of mechanical devices that can translate the power potential of that pressure into work or motive power. It is a core technology. It will have very wide applications as the potential power source not only in passenger motor vehicles of all kinds, but also for truck transportation and trains carrying payloads. Equally, it may be applied with boats and large container carrying sea vessels. Virtually, it may have applications in any other situation that requires mechanical power. It can also have uses in situations where waste heat is available.

Finally, if cryogenic fluids are utilized as a medium for power storage, (especially pertinent with temporary power storage with some of the new renewable energy sources such as wind), this technology can be utilized to regain a more rapid and efficient usage of that stored power.

2. History Of The Technology & Prior Art

The use of an engine powered by the expansion of cryogenic fluids, (typically Nitrogen), was most notably proposed in the 1970's/80's by the highly respected scientist, Dr. Harold L. Boese, who has also been called the “Father of Modern Cryogenics”.

He was granted U.S. Pat. No. 4,294,323 on Oct. 13, 1981.

Other inventers have patented variations of thermal engines granted both before and after Dr. Boese. Most use the concept of the cryogenic working fluid being expanded in a series of heat exchangers:

| Patent # | Date Granted: | Inventor(s): |
|---|---|---|
| 3986359 | Oct. 19, 1976 | Manning, et al. |
| 3998059 | Dec. 21, 1976 | Randell |
| 4023366 | May 17, 1977 | Schneider |
| 4106581 | Aug. 15, 1978 | West, et al. |
| 4195481 | Apr. 1, 1980 | Gregory |
| 4294323 | Oct. 13, 1981 | Boese |

Dr. Boese developed an engine based on the use of Liquid Nitrogen (N2), which is mostly inert, non-flammable, and comprises about 78% of our atmosphere in its gaseous state. It is therefore universally available. He converted a Pinto station wagon to run on the expansion of that fluid. The basic principle was that when Liquid Nitrogen, which was stored in an onboard insulated tank called a “De Warr Flask”, came in contact with ambient temperature air through the use of a “turbo expander” which functioned as a heat exchanger, that the Liquid N2, which will expand approximately 650 times in volume as it goes through the phase change from liquid to cold compressed gas and then further expanded to ambient air temperature gas at approximately 70 Deg. F. An air motor was then utilized to turn the pressure created and the power of that expansion into a utilizable form of mechanical energy to propel the vehicle forward.

There is some controversy as to wither or not Dr. Boese's design was used as a back-up engine by NASA on the Lunar Rover, but at any rate, Dr. Boese spent the last part of his life trying to promote and market the use of his innovation as a non-polluting vehicle motive power with little apparent success. He died in 1988. The company that was formed, Cryogenics Unlimited Corporation, tried to continue work in the U.S., Japan and Italy, but no long term commitments were made to assure further developments. Unfortunately, when the oil embargo of that era lifted, both federal and private funds for further research and/or investment in the field rapidly dried up and stayed unavailable for a number of years.

More recent developments with the outlook of future limited oil supply, spiking gasoline prices and global warming have brought the concept back into current re-consideration.

Two University groups, one at the University of Washington, and one at the University of North Texas have built working prototypes using similar concepts, but with more advanced and efficient heat exchangers. The group at the University of North Texas is comprised of Dr. Carlos Ordonez, Dr. Rick Reidy, and Dr. Mitty Plummer, and they have a list of published technical papers from 1996 through the present.

(see http://www.mtsc.unt.edu/CooLN2Car.html—see reference sheet found on the last page of this document)

Their design for a “cryo-car” also used most of the components that Dr. Boese used, and included heat exchangers. They produced a basic prototype that operated but had a limited amount of success. Not enough to make the vehicle commercially viable yet. There were a few engineering problems that stood in the way of a greater success.

One is with the heat exchangers themselves. There is a potential problem of icing up from moisture found in ambient air and when it occurs it decreases the efficiency of the heat exchangers in their function. As a University of Washington paper in 1988 entitled “High efficiency conversion systems for Liquid Nitrogen Automobiles” stated:

“Frost Formation: Unlike internal combustion engines, using a cryogenic fuel requires heat exchangers to warm and cool the working fluid. In a humid environment, frost formation will prevent heat flow and thus represents an engineering challenge. To prevent frost build up, multiple working fluids can be used. This adds topping cycles to ensure that the heat exchanger does not fall below freezing. Additional heat exchangers, weight, complexity, efficiency loss and expense, would be required to enable frost free operation.”

Another problem was that they utilized off the shelf air motors in their prototype which functioned to a maximum pressure of approximately 140 psi rather then being able to utilize the higher psi pressures that could be generated from cryogenic expansion.

A far greater limitation though was that they only used ambient air temperatures in combination with the heat exchangers in their prototype. These ambient temperatures were not able to expand the super cold cryogen liquid to gas rapidly enough or completely enough in a small enough and commercially viable enough apparatus. So they did not get the most rapid, efficient use and full expansion of the liquid cryogen that could be gained.

Mr. Michael Nowacki, a lay inventor, and possibly a few others have introduced the concept of a Hybrid Power Cryogenic Engine. It would endeavor to utilize the high temperature waste heat of an internal combustion engine, (or potentially any waste heat source), in conjunction with a cryogenic fluid and the heat exchanger of a cryogenic engine to gain a far faster and possible greater amount of expansion efficiency from the cryogen fuel then just by utilizing ambient air and ambient air temperatures. But it still utilized heat exchangers!

Another interesting engine concept concerning waste engine heat is found in U.S. Pat. No. 6,796,127—Sep. 28, 2004—John F. Helm, inventor, which describes a “one cycle” engine that utilizes a double acting piston that is propelled by an internal combustion of diesel fuel from one side and by steam created from the combustion waste heat on the other side.

The development of these ideas are in great part based on the fact that in most internal combustion engines, only about 24-28% of the fuel is used efficiently towards motive power. The other approx. 72-76% is lost as heat and friction. Of that part lost as heat, over 70% of it is found in the hot exhaust gases that travel to the tail pipes. (The other heat is radiated off the engine assembly in direct convection or is taken away from the engine block via the coolant fluid system.)

In an Internal Combustion Engine, if the excess heat generated by the burning of the fuels is not rapidly removed from the engine block it would build up high enough heat to melt itself.

A huge amount of engineering thought and great innovation during the twentieth century has gone into making the internal combustion engine more efficient and also more powerful. Furthermore, in ways endeavoring to use its fuel more efficiently and completely as well as burning it more cleanly. I contacted Mr. Michael Nowacki after I was referred to him in a return e-mail from Dr. Mitty Plummer at the University of North Texas. We briefly attempted to work creatively together and had one meeting on Nov. 17-18^{th}, 2006. In the course of mutual creative exchanges and discussions we had a minor co-invention breakthrough. He was explaining to me a concept that he had originally had back in 1997 but had abandoned as not functional or workable for very good reasons. As I listened, I saw a simple but profound major adjustment that could make the approach workable. His original abandoned idea in 1997 had been to inject liquid nitrogen into the working cylinder of a typical diesel engine right at the same time that the explosion of the diesel fuel was beginning to happen. Thus, Mr. Nowacki's first idea was that the heat from the explosion would expand the cryogen and create a new utilization of both diesel fuel and cryogen. He abandoned it because the intense cold of the cryogen would in fact inhibit the heat expansion of the air in the cylinder as the explosion is occurring. They would be fighting against each other.

What I saw at the time of that discussion in my office was that the expansion of the cryogen could be done in a separate chamber or cylinder, and then it would work because the forces wouldn't be fighting against each other. Or in other words, take the hot exhaust, or “waste heat” from the first diesel cylinder, and channel it into a secondary cylinder, where there would then be cryogen injected into it which would expand rapidly in the high heat atmosphere of the waste heat, and whose expansion could be utilized to push the piston in the 2^{nd} cylinder and create additional mechanical power.

When I saw it I said to Michael:

“It can still work . . . you just use a second cylinder” and then we both instantly saw that it might work. Michael drew a crude picture of it and we dated and signed it. I then developed a few small further refinements to that concept on my own and then typed and drew up a Provisional Patent Application independently to document the breakthrough. It was mailed on Dec. 22, 2006 and received at the U.S.P.T.O. on Dec. 26^{th}, 2006, and listed both Michael and Myself as co-inventors. Its title was “Hybrid/Cryo Power Train”. (It was never, however converted to a Regular Patent Application because on further intense study and innovative thought, I found flaws in the concepts overall efficiency and workability.)

Though I tried very briefly to form a partnership with Mr. Nowacki back in 2006 to promote that concept/co-invention, he had no interest in doing so . . . and told me so in a phone conversation and in no uncertain terms in an e-mail dated Dec. 17^{th}, 2006. So, our first face to face meeting to share our innovation and business abilities, also was our last.

Since that point I have continued to work creatively and completely independently on the further development and refinement of my understanding. I hired an engineer to get myself generalized calculations of potential power output and costs of that output so that I could translate the figures into projections of commercial and competitive value on the marketplace. He reported output and efficiencies to me all in BTU's. That had an interesting effect on my thinking . . . pure total BTU's of potential fuels (or also known as the ‘energy density’ of the fuels).

While I continued to work independently, over a twelve month period of time, I came up with very significant new and unique thought breakthroughs and developments, one after another, that changes the nature of my approach to an apparatus.

### OBJECTS AND ADVANTAGES OF THE PRESENT INVENTION

I have designed two different methods for rapidly expanding cryogenic fluid to create useful power. The one that utilizes pistons and factors of heat from compression in an enclosed cylinder is described in a separate provisional patent application with a different RPA to follow than this one.

The subject of this RPA utilizes a larger mixing ‘chamber’ in which to carry out the heat transfer and the rapid power expansion of liquid cryogen into high pressure gaseous air. This pressurized air may then be applied in any of a wide number of applications. The scope of this RPA does not limit the ways that this core technology can be applied at all. It shows a new and unique method for rapidly creating pressurized air on demand. Depending on which application you eventually desire to utilize it in conjunction with, you are sending the channeled pressurized air (102) via the PRESSURE DELIVERY CHANNEL (104) to do work, (or be properly stored to do work later.) For examples, this could be accomplished using an air motor; or using a turbine; or with using one or more pistons which are inline, opposing, or reciprocating; the pistons can drive a crankshaft with flywheel . . . etc. In other words, it is understood that this core technology is intended to be combined with all the current technologies available that can translate high pressure air into work or motive power. I understand that it has wide scope of application and I do not limit that scope.

For convenience and clarity's sake, plus to do power efficiency and cost comparisons of its usefulness and competitiveness, I will only refer to its use for motive power for a passenger vehicle with the understanding that it may be applied in a wide number of other ways.

The present invention, The Hybrid/Cryo Power Chamber, (HCPC), accomplishes the creation of on demand useful power potential, (pressurized air), in a simple, elegant and direct manner. And it does this with high thermal efficiency.

“Fuel” is of course stored energy. Previous prior art attempted to utilize the stored energy potential of the expansion of liquid cryogens by running the liquid through a single heat exchanger or with a more complex series of heat exchangers. The expansion capability of those prior art devices was not rapid or complete enough to provide “practical” power in most cases. “Practical” here is defined as; 1. On Demand; 2. Efficient full utilization of the ‘fuels’ potential; and 3. with a cost effective device.

Our apparatus offers a simpler and more direct method for providing large quantities of pressurized air to be utilized. It has a single mixing chamber which can be inexpensively commercially designed and also very compactly designed and yet still be highly effective.

(You can see from the four different chamber shape examples from my figure drawings that a wide variety of different shapes can be utilized—especially desirable in a preferred embodiment would be the most cost effective to produce and easily maintainable shape, but the technology is not dependent on any one particular shape.)

The “heat producing” fuel utilized will be close to 100% burned in the high pressure and thus oxygen rich atmosphere. (Higher fuel concentrations of oxygen could be created to accomplish the desired top efficiency). This is an improvement of fuel utilization over the present internal combustion engine, (ICE), which has only around 28% efficiency use of the heat potential of the fuel. In the ICE the other part of the heat must be removed from the internal combustion engine as rapidly as possible so that the engine blocks are not melted.

Our apparatus does not need to dissipate any of the heat created by the burning of the heat producing fuel. In fact, the chamber of our apparatus is highly insulated to keep close to 100% of the heat held within to be utilized to rapidly expand the other symbiotic fuel, the liquid cryogen.

An engineering study estimated that an example heat producing fuel, propane, which has his listed heat potential of 91,547 BTU's/gallon, will fully expand approximately 35 gallons of liquid cryogen to ambient temperature.

As liquid cryogen phase changes and rapidly expands from its liquid state to its gaseous state at “ambient air temperature”, (70 deg. F.), it expands approximately 700 times in volume.

Physicists estimate that a fully enclosed chamber with no outlet, a given quantity of liquid cryogenic fluid expanded completely to ambient temperature gas would create a pressure well over 30,000 psi.!!—That is a rapid power expansion to contemplate . . . and to harness for motive power or other useful applications.

### OTHER OBJECTS AND ADVANTAGES

In today's world, while thinking about creating any power source that will have, among other things, broad applications in transportation, you must hopefully endeavor to present a solution that covers at least these seven important areas:
1. That your solution significantly lessens the production/release of greenhouse gasses;
2. That it's price competitive in cost per mile with gasoline or diesel fuels;
3. That the fuel can be mass produced and distributed;
4. That the vehicles which use it have some or all of the performance characteristics that current technologically advanced transport vehicles do;
5. That the vehicles themselves, which utilize the new technology, can be cost competitive;
6. That the new systems will catch the fancy of the worldwide buying public in all application areas and will be readily adopted;
7. And finally that the “well to wheel” energy consumption of the overall systems of the new technology be efficient and actually assist in helping solve the projected energy and fuel shortfalls worldwide as India, China, and others become more advanced and use more fuel, more transport, and more electrical energy consumption.

Fortunately, and very excitingly, the new technology proposed in this Regular Utility Patent Application, can answer strongly in the affirmative in each of the areas outlined above.

I'll address each of the above, and also how our technology provides workable solutions or is an improvement over prior art and current technology.

1. It significantly lessens greenhouse gas emissions because the “primary fuels” are liquid nitrogen and liquid oxygen whose exhaust pipe product is simple pure air. The heat producing fuel will have some exhaust elements that need to be dealt with but will produce a great deal less of it than in current autos. And our apparatus can use a number of fuels for the heat component including: propane, alcohols, hydrogen, natural gas, liquefied natural gas, syngas, bio-diesel etc. The cleaner options have much cleaner emissions than from fuels current vehicles. It's true that electricity will be utilized to manufacture the cryogenic primary fuels components, and so the environmental friendly-ness is only as good as the source used to create the electricity . . . but a few exciting factors will come into play:
Cryogen Fuel can be manufactured at night using less expensive night-time power and using some power from renewable source wind that is in some areas delivered more predominantly at night and/or from underutilized night-time hydroelectric power. Also, in separate patents that I will be submitting, I can outline ways to practically utilize as yet untapped wind sources and potentially other renewable energy sources for ‘cryogenic fuel’ manufacture. ‘Cryogenic Fuel’ is similar to hydrogen fuel in that it is simply Stored Energy.
Amounts of energy will be saved in the shipping and transport of oil and in the manufacture and refining of gasoline. All Cryogen fuels can be manufactured in close proximity to their distribution and use.
   2. It will be cost competitive when compared in cost per mile with the use and cost per mile of gasoline fuels. A car, (Honda CRX example), that uses gasoline @ $3.00 per gallon and gets 25 mpg . . . will have a cost per mile of $0.12

A cryo car will travel approximately 5 miles per gallon of cryogen (Also using a Honda CRX—which the University of Washington used for their mileage calcs.) @ 0.30 per gallon cost of cryogen, that is $0.06+the cost per mile of the heat producing fuel:

1 gallon of propane, (an example heat producing fuel), to fully expand every 35 gal. of cryo-fuel using BTU formulas

@ $1.90/gal cost of propane divided by 35=$0.055 and that figure will be divided by 5 miles per gallon or will equal an additional 0.01 cost per mile}
Final cost per mile of an example cryo-car $0.11½ per mile—slightly under current gasoline cost by $0.01½ per mile.

Note: I am using examples of an automobile . . . but remember that this new power source can be applied to other kinds of vehicles including trucking, container vessels, trains and mass transit as well as in electric power production when energy is temporarily stored in Cryogen Fluid and then a portion of that energy is recovered via use of this apparatus.

3. The fuel can be mass produced and delivered. Liquid cryogen plants are already operating commercially worldwide. Liquid nitrogen and oxygen is already transported along highways and by train and the technology to store, transfer and transport it is well developed.

An additional huge benefit—Modern Cryogen producing plants are very clean and non-polluting. And they are also very safe. They can be and are currently sometimes located close to residential areas without concern. The problem of finding sites for new gasoline refineries which nobody wants in their backyard could eventually become a concern of the past.

4. An exciting feature of the torque performance characteristics of using a liquid cryogen as a fuel is that the re-expansion of the cryogen into a gas produces power that acts similar to the characteristics of steam engines once it has developed a head of steam. Specifically, our apparatus, the Hybrid/Cryo Power Chamber, will almost instantly develop high torque at low speeds, but without wasting some excess fuel like a gasoline engine will when you “punch it” to develop speed rapidly from a standing start or in situations like in passing another car.

This is a performance feature that modern drivers often look for and are not always willing to settle for not having in their vehicles. It will also have torque to travel up hill while carrying a load.

The prior art prototypes of cryo-cars that the U. of Wash. and U of North Texas developed had restricted top end speeds and did not utilize all of the power potential of the cryo fuels because of limitations of the performance of the heat exchangers.

Our power chamber, which maintains a beginning working pressure at all times, from that point has the ability to rapidly develop very high pressure flows and thus higher top end speeds and competitive performance torque that will impress critics.

5. Once the Hybrid-Cryo Power Chamber is broken down and analyzed, it is immediately apparent that it is much simpler and less expensive to construct than a standard internal combustion engine. Because it has far less moving parts and its operation is basic and fundamental . . . it will also be constructed so that it will last far longer and be much less expensive to maintain. This will make it very attractive . . . especially as a “renewable” and far cleaner fuel. This attractiveness should more than balance out the need to carry a larger fuel tank to have the same travel range because of the lesser energy density than that of fossil fuels.

Repeating a fact stated earlier . . . the engine can weigh significantly less than an int. combust. engine (I.C.E.), and that fact will help balance the weight of extra fuel carried.

6. It is fair to say that this new power system will catch the fancy of the buying public. Not that many people will want to argue with far cleaner, mostly renewable, cost competitive, and desirable performance characteristics. Of course it is always difficult to have the public begin to use something that will require new equipment (vehicles) and a new system of fueling . . . but in this area we know the public is very ready because of global warming.

And, there are ways, with this particular technology, to phase in its introduction and also to phase in availability of widespread fueling stations. In addition, an attractive fact about cryogenic fuel production is that it is totally scalable. Larger production plants are more efficient but there already exist small scale cryogenic production units which take up a small space—already commercially for sale—that could very easily be adapted for home fuel production and there is also existing technology developed to easily to transfer cryogen fluid. (i.e.—fill up your tank at home.) And production could be done at night, which is better because of lower beginning air temps., and also night time electricity is cheaper. It is not hard to also foresee potential tax breaks and electricity credits for early adopters to encourage the early adoption of the new and very beneficial technology.

7. Finally, the facts of the energy consumption and usage patterns for the overall “well to wheel” energy formula of this new technology is going to be interesting to many. Those in the field of supplying electricity via utility companies for the publics consumption are already painfully aware that worldwide, we are constantly stretching to keep up with growing demand. The introduction of a new renewable fuel that is created in plants (or at home) via the use of compressors that run on electricity is a bit daunting on first look. Fortunately, as has been stated, the bulk of production can be done at night, when other uses of electricity are lowest. On one hand, this can also provide and outlet for the profitable sale of energy generated by wind at night and also for energy generated by existing hydroelectric and other power plants which must run all throughout the night at a bare minimum level.

On another hand, I am also developing an entirely new field which, because of the energy storage capacity of liquid cryogens, will allow them to be produced in entirely new geographic locations. This will be the subject of a separate regular patent application.

It will go a long way towards providing a significant percentage of the fuel demands that will help make the “package” of this new fuel technology and the solutions it offers quite acceptable. Much more on this in that separate patent application.

Other attractive factors relevant to “well to wheel” deliveries are:
The amount of energy used to refine oil into gasoline will be saved.
The fuel and energy utilized to pump and transport oil to consuming nations will be saved. As well as the transport of gasoline from refineries to gasoline stations will be lessened because production of cryogenic fuels can be done much closer to the locations where they will be purchased and consumed. And since cryogen plants are clean an safe, they can be located in a far greater number of locations. There are other options for bigger central plants being a hub for a number of smaller plants that do the final phase of processing. More on this will also be introduced later and in detail to the commercial developers as a part of the overall production and delivery infrastructure that I have developed along with the technology . . . which gladly is practical and attainable “without breaking the new infrastructure bank.”

### SUMMARY

Our apparatus provides a substantially enclosed chamber in which to rapidly expand injected cryogenic fluid in a heated atmosphere by also burning a heat producing fuel within that chamber. The rapid and highly efficient expansion of the cryogenic fluid into a high pressure gaseous form, in a controlled and regulated manner, is then channeled via some form of a pressure delivery channel (104), which is the power chambers only practical path of release, to then perform useful work. This on demand, high pressure air or high pressure nitrogen can be utilized or translated in a very wide number of applications to create motive power or other forms of useful power.

This is a simple, effective, cost competitive and relatively uncomplicated apparatus that is a great improvement over the limitations of prior art that utilized different kinds of heat exchangers which were not as effective.

### BRIEF DESCRIPTION OF THE DRAWINGS

Special Notes: I am using the technique of “diagrammatic side view” or “diagrammatic top view” here and in the other drawings because I can not draw perspective drawings that will appear as clear or as accurate.

In all of the drawings, please assume that they all contain three dimensional parts, rather than the flat objects that are shown in my diagrammatic cut away drawings.

Also, that all parts will be properly bolted or otherwise firmly connected to the functional structures that will utilize the Hybrid Cryo Power Chamber concept contained in this patent application.

And, finally, I am showing all the parts and their connections and functions, but its assumed that they may be arranged in different practical locations, again according to the function to which the core principles are being adapted.

### Drawing #1—“Hybrid/Cryo Power Chamber”—

### (Preferred Embodiment)—Diagrammatic Side View:

Shows a rectangular box shaped Power Chamber 80 with a heat fuel burner encased and sealed inside it. The burner 77 is being fed a heat producing fuel. The Cryogen Fuel Spray Injectors 90 are being fed mixed “liquid air” (liquid nitrogen+liquid oxygen) from the Cryogen (Liquid Air) “Fuel Tank 84 so this mixture will also supply the combustion oxygen for the burners. Part #111 in the drawing signifies a mixer to keep the two cryogens from separating while in the tank. If need be, could be two separate cryogen tanks with two separate feeds to the Cryogen Fuel Spray Injectors (90).

### Drawing #2—“Alternate Shaped Chamber”

### Diagrammatic Side View:

This drawing shows a different shaped chamber—it helps demonstrate that any number of different shapes can be adapted to utilize the basic principles and core concept that this patent covers—we do not limit the shapes of chamber that can be utilized within the scope of our patent application. It also has the added feature of a Turbulence Creating Form (103)—turbulence being one method of assisting rapid mixing and heat exchange between the heat from the heat producing fuel, and the spray atomized injection of liquid cryogen. Feature #111 Liquid Air Mixing System was put in to this drawing #2 also (because it was included in drawing #1 but was mistakenly overlooked in the 1^{st} RPA submittal)

### Drawing #3—Alternate Chamber Shape &

Alt. Feature—Elongation of Pressure Delivery Channel (104)
Diagrammatic Top View—Chamber and Channel only

This drawing shows a cylindrical shaped Power Chamber with the addition of a feature that extends the total length of the Pressure Delivery Channel (104) by wrapping it around the chamber before it gets to the “Working Pressure Release Door” (99). This length extension of the Pressure Delivery Channel allows more time for the heat and cryogen mixing to occur—another feature to increase the thermal use efficiency. (It could obviously be lengthened in other ways with many different design shapes).

### Drawing #4—Alternate Embodiment—Variation on Heat

### Burner and Heat Exchange Method

### Diagrammatic Side View—

In this embodiment, we show the burner for the heat producing fuel to be enclosed within its own Separated Heat Creating Burner Chamber (105) located within the Main POWER CHAMBER (80). There is only heat exchange but no air exchange between the burner chamber (105) & Convoluted Heat Transfer Pipe (107) and the main POWER CHAMBER (90). The Burner (77) is fed with ambient temperature air via the “Combustion Air or Oxygen Supply Inlet” (106). In this embodiment, either liquid air or just liquid nitrogen could be supplied from the cryogen fuel tanks because oxygen for the burner is supplied from outside.

Drawing #5—Alternate Embodiment with a Separate
Cryogenic Oxygen Tank supplying the Burner

### Diagrammatic Side View—

In this embodiment there is a separate Cryogenic Liquid Oxygen Tank 84B. supplying combustion oxygen to a different representation of heat fuel burner. The Cryogenic Liquid Oxygen Supply Line 110 pre-heats the cryogenic oxygen by two methods before it enters the POWER Chamber 80:

1) via electric pre heat via line 109; and

2) via heating of the last part (after the fuel regulation valve 88) of the supply line 110 that connects to the POWER CHAMBER and will receive heat via convection from the flame of the heat producing fuel 79 itself as can be seen.

This embodiment also shows a variation of the Turbulence Creating Form 103, which can be many different kinds of shapes.

The scope of this patent does not limit the shape of the Turbulence Creating Forms 103 whose purpose is to effect efficient mixing.

NOTE: Drawings 1-4 were included into the Provisional Patent Application while the Drawing #5 was added for the Regular Patent Application submission.

### FIGURE REFERENCE NUMERALS

71 Fuel Tank—Heat Producing Fuel
72 Fuel Tank Filler Port
73 Pressure Release Valve
74 Fuel Supply Line—heat producing fuel
75 Pump—to pressurize fuel into burner or
   Pressure Regulator—depending on which fuel is used as the heat producing fuel
76 Fuel Regulation Valve
77 Burner—heat producing fuel
78 Igniter
79 Flame—of heat producing fuel
80 POWER CHAMBER
81 Power Source to Igniter
82 Thermal Insulation—around power chamber to keep heat inside chamber
83 Thermal Insulation—to keep heat away from cryogen tank
84 Cryogen (Liquid Air) “Fuel Tank”
Alt. Embodiment: 84A Liquid Nitrogen Cryogen Fuel Tan
84B Liquid Oxygen Cryogen Fuel Tank
85 Cryogen Fuel Tank Filler Port and Cap
86 Cryogen Pressure Relief Valve
87 Cryogen Pump—to increase fluid pressure to injectors
88 Cryogen Fuel Regulation Valve
89 Cryogen Fuel Supply Line
90 Cryogen Fuel Spray Injectors
91 Central Control and Coordination Unit
92 Control Wire to Accelerator ‘Pedal’
93 Accelerator ‘Pedal’
94 Control Wire to Burner Igniter
95 Control Wire to Fuel Regulation Valve (for heat producing fuel)
96 Information Wire from Pressure and Temperature Gages
97 Pressure Gage
98 Temperature Gage
99 “Working Pressure” release door
100 “Working Pressure” Release Door in an open position
101 Pressure Release Regulator—represents a spring or other apparatus that allows “working Pressure” release door to begin to open at a pre-set pressure and stay open until the pressure drops back down to the “minimum constant working pressure”
102 Path of Travel Arrows
103 Turbulence Creating Form
104 PRESSURE DELIVERY CHANNEL
105 Separated Heat Creating Burner CHAMBER
106 Combustion Air or Oxygen Supply Inlet
107 Convoluted Heat Transfer Pipe(s)
108 Heat exhaust pipe
109 Electric Pre-heater
110 Cryogenic Liquid Oxygen Supply Line
111 Liquid Air Mixing System

### DETAILED DESCRIPTION

### Physical Description

Figure I shows a diagrammatic side view of the Power Chamber.

The main Power Chamber 80, is a substantially enclosed chamber. It can be a complete sphere, a square box, a rectangular box, or any other shape that is fully enclosed with the exception of the “working pressure release door” which provides its only outlet when inn an open position. It will be bolted down or attached to some fixed structure (not shown). It has within it a burner 77, that is supplied with a burnable heat producing fuel via a supply line 74, that has a controllable valve which opens and closes to varying degrees, and a Pump or pressure regulator 75. The supply line 74, is attached to a fuel tank 71, which has a filler port 72, and a pressure release valve. The supply line 74, as it enters the power chamber 80, is tightly sealed so that it will hold the substantial amount of pressure generated in the power chamber without leaking.

Inside the power chamber, the burner 77, has an igniter 78, to ignite the heat producing fuel which produces a hot flame 79. It is attached to a power source to igniter 81, which is controlled by the “Central Control and Co-ordination unit” via a control wire 94.

The Power Chamber 80, which is constructed of a material to withstand the high pressure created, is heavily and completely insulated with thermal insulation 82, to keep the heat to be utilized held within. There are one or more Cryogen Fuel Spray Injectors 90, Two are shown in Figure I, that spray an atomized mist of cryogenic fluid into the Power Chamber 80. The spray injectors are also tightly sealed as they pass into the power chamber 90, to be able to hold in high created pressures. The injectors are attached to the Cryogen Fuel Supply Line 89, which has a Cryogen Fuel Supply Regulation Valve 88, on it and also a Cryogen Pump 87, on it. Both the Valve 88, and the Pump 87, have control wires that are connected to the Central Control and Coordination Unit 91.

The Cryogen Fuel Supply Line 89, is connected to the Cryogen (Liquid Air) Fuel Tank 84 which has a Filler Port and Cap 85, and a Cryogen Pressure Release Valve 86. The Cryogen (Liquid Air) Fuel Tank 84, will have within it a mixing means not shown to keep the liquid oxygen and the liquid nitrogen that compose the liquid air from separating. Both the Cryogen Fuel Tank 84, and the Cryogen Fuel Supply Line 89 have specialized Thermal Insulation to keep heat away from contact with the cryogenic fluid.

Typically, this is a created vacuum area around the lines or tanks that does not allow any significant amount of heat transfer.

Figure I is a diagrammatic side view which does not show exact locations of tanks and other fixtures or that they are all held in place in some manner so they do not move around, which will be necessary and is assumed.

The Central Control and Coordination Unit is connected to temperature and pressure gages 98 & 97, via control and information wires, and is also connected via the Control Wire to the Accelerator Pedal 92, to Accelerator Pedal 93, or other power output regulation device. Exiting out of the POWER CHAMBER 80, is the Pressure Delivery Channel 104 that is also attached to the Chamber in a continuous or tightly sealed manner. It has a operable Working Pressure Release Door 99, that is shown in its closed position 99, and by dotted lines in its Open Position 100. It has a spring or other Pressure Release Regulator 101, that allows the pressure built up in the Power Chamber 80, to release when attains a certain preset level and to remain in the open position 100, until the “working pressure” falls below that preset level and then it closes automatically. The Path of Travel Arrows show the direction the working pressure travels. Figure I does not show a connection to any further device, but rather has cut off lines. This is because there are a wide number of different applications that this working pressure can be connected to.

It is assumed in all the different Figure Drawings that the Pressure Delivery Channel 104, will always be connected to one or more work applications or motive power means in an efficient manner to gain the most work or motive power possible. This will also always be done with a seal between the Power Delivery Channel 104, and the application device, not shown, that does not allow working pressure to be unnecessarily leaked or lost.

Figure II shows a different shape of Power Chamber 80, to achieve different mixing patterns of the heat generated from the burner 77, being rapidly mixed with the liquid cryogen being injected into the Power Chamber 80. Also shown is a representation of a air Turbulence Creating Form 103, to help create turbulence inside the Power Chamber to assist in more rapid mixing. The dotted lines of the Cryogen Fuel Supply Line 89, indicates that the line is passing behind and outside of the substantially enclosed Power Chamber 80.

Figure III shows a variation detail, (top view), of a substantially enclosed cylindrical Power Chamber 80, that has a Pressure Delivery Channel 104, that circles around next to the chamber which allows a greater physical distance for the heat generated by the heat producing fuel and Burner 77, and the liquid cryogen spray dotted lines emanating from the Cryogen Fuel Spray Injectors 90 to be physically effectively mixed in before the pressurized gas that is a product of that mixing reaches the “Working Pressure Release Door” 99.

Figure IV shows an alternate embodiment with the following different physical features: In this embodiment, the Burner-off heat producing fuel 77, is located within its own separate and enclosed chamber that is located within the main Power Chamber 80. The Burner 77, is still supplied with fuel from the Fuel Supply Line—heat producing fuel 74, but its combustion oxygen, instead of coming from the expanded oxygen component of the liquid air injected by the Cryogen Fuel Spray Injectors 90, as it is in Figure I, instead comes from a separate Combustion Air or Oxygen Supply Inlet 106. This can come from simple ambient air supply as shown, or from a turbo injected air supply, or other options to supply efficient amounts of combustion oxygen to the burner. The Burner 77, being separately enclosed within the power chamber 80, creates heated air that transfers its heat to the power chamber via convection as its Convoluted Heat Transfer Pipe(s) 107, wind back and forth within the power chamber 80 before exiting the combustion exhaust out to the atmosphere via the Heat Exhaust Pipe 108. Presumably there will also be elements (not shown), that will remove unwanted combustion elements from the exhaust before it exits to the atmosphere as desired or as required by state or federal laws.

In the Figure IV drawing . . . the pipe shown is a representation. For effective heat transfer, the Convoluted Heat Transfer Pipe 107, will have more convolutions within the power chamber 80 before exiting, it will be smaller in diameter, and it can have multiple pipes that emanate off from the Heat Creating Burner Chamber 105, all connected in a sealed manner and eventually exhausting out to the atmosphere as the Figure IV drawing shows with just one pipe. The point where the Heat Exhaust Pipe 108 exits from the Pressure Delivery Channel 104 needs also to have a tight pressure seal to not leak the working pressure wastefully. This of course is true of any penetration of the Power Chamber 80, and also of the Working Pressure Release Door 99, when it is a closed position.

Figure V shows another alternate embodiment. The physical shape of the Power Chamber 80 is again a different configuration to create different mixing patterns between the heat and the Injected Cryogen Spray. In this embodiment, there are two Liquid Cryogen Fuel Tanks. One larger one—84A that holds Liquid Nitrogen Cryogenic Fluid, and a smaller one—84 B that holds Liquid Oxygen Cryogenic Fluid. The Liquid Oxygen Cryogen Fuel Tank 84B, feeds into the Power Chamber next to the Burner—heat producing fuel 77. It provides the combustion oxygen to the burner. The Cryogenic Liquid Oxygen Supply Line 110, is heated by an electric pre-heater 109 that is operated directly from batteries not shown and/or also from an ultra-capacitor not shown. They get their power from a mechanism that translates some small amount of the power from the air pressure to a charging mechanism not shown.

The Burner—heat producing fuel 77, shown in this Figure V variation, is a single jet burner that more resembles a blow torch. It blows, along with the force of the injected combustion oxygen supply, directly against the Turbulence Creating Form 103 to create turbulent heated Oxygen and injected Spray Nitrogen Cryogen mixing inside the Power Chamber 80.

The Injected Nitrogen Cryogen Spray comes through the injectors 90 and from the Liquid Nitrogen Cryogenic Fuel Tank 84 A.

In this embodiment, there is also shown another design for creating a longer amount of Pressure Delivery Channel 104, before it gets to the Working Pressure Release Door 99.

### OPERATION OF THE INVENTION

The apparatus operates to supply either high pressure gaseous air or high pressure gaseous nitrogen to be utilized for motive power or some other form of useful work. It does this by the following operation:

We have some form of a substantially enclosed chamber with only one avenue for the high pressure gas to escape from in a regulated manner so as to perform greater or lesser amounts of work depending on the throttling of the apparatus which is represented by a accelerator pedal 93, but could be any number of other types of mechanism to perform the same task.

When you step on the accelerator pedal 93, it gives a signal via the control wire to accelerator pedal 92. This signal goes to a Central Control and Coordination Unit 91 which first sends a signal to the Fuel Regulation Valve 76, on the Fuel Supply Line—heat producing fuel 74, to open an amount corresponding to the amount of power desired and send heat producing fuel to the Burner 77.

There the igniter 78 is also signaled from Central Control 91, to ignite the fuel to burn and begin to create a heated atmosphere within the chamber. A moment later, the Cryogen Fuel Regulation Valve 88, located on the Cryogen Fuel Supply Line 89, receives a signal to open and allow “Cryogen Fuel” to flow to the Cryogen Fuel Spray Injector(s) 90 and be sprayed into the Power Chamber 80. Ideally, with the preferred embodiment, the cryogen fuel will be sprayed under pressure created by the Cryogen Pump—to increase fluid pressure to injectors 87. Ideally, it will also be atomized by the injectors 90 as it is injected. The beauty and function of the POWER CHAMBER 80 is that it rapidly and efficiently mixes heated air from the burner with injected atomized cryogenic fluid to assist in the rapid and “complete” expansion of the cryogenic fluid into high pressure gas. Factors that assist with this “mixing” are: That the chamber is sized and shaped so that the most efficient mixing may occur; the cryogenic fluid is injected under pressure and atomized and the injectors are pointed down or in such a way as to push the atomized cryogenic fluid with force into the heated combustion product; and the complete mixing con continue to occur as the air expands and begins to push with force down the PRESSURE DELIVERY CHANNEL 104.

It is important for the efficiency or efficient utilization of both fuels that the proper amount of heat be made available to the “proper amount” of cryogenic fuel. If too much heat is created, the cryogenic fuel will be “fully expanded” (pressurized) and there will still be excess heat available that is “wasted” as it travels out of the apparatus to do its work. If too much Cryogen is injected into not enough heat then the cryogen will remain not fully expanded and excess compressed cold gas will be traveling out from the power chamber apparatus. The highest efficient use can be regulated though. It is a fixed scientific ration which dictates how much heat is needed to “fully expand” the cryogen. And “fully expand” is a bit of an arbitrary term. With even more heat the gas will expand even more and create more pressure, however the heat producing fuel is more costly than the liquid cryogen so we will arbitrarily define fully expanded as being “bringing or expanding the liquid cryogen until it attains ambient air temperature or 70 Degrees F. The power chamber may be set to have an expanded product at different final temperatures according to different applications or different desires for efficiency. It is not limited in that way. [It may be useful to note that Liquid Cryogenic Air expands approximately 175 times in volume as it phase changes 1 Degree from liquid to compressed gas. And then it expands another 3.7 times as it goes from very cold compressed gas to gas at ambient air temperature. This approximately provides a total volume expansion of 175×3.7=645 times in volume. This could theoretically create a pressure of 49,000 psi in an enclosed container. The greater part of the expansion happens during the first part of the expansion with diminishing amounts of returns on your heat fuel investment happening as we get closer to ambient temperature. So the designer of any particular application use will somewhat arbitrarily decide to what temperature they want to heat the cryogen to. {Gasoline engines also use heat in the form of rapid burning/explosion to rapidly expand air to harvest utilizable power} Both the Internal Combustion engine and the Power Chamber are “Heat Engines”.

It is also important to note that because the Liquid Air that is found in the Cryogenic fuel tank 84, of Figure I will not have water moisture within it, (the water content of air as well as the C02 content is removed during commercial production of cryogenic fuels), and the heavy insulation around the Power Chamber, will help to alleviate icing-up problems found in many of the Prior Art cryogenic engines that utilize heat exchangers and ambient temperature air with moisture content. The Hybrid/Cryo Power Chamber apparatus accomplishes the desired proportional mixture of heat and sprayed Cryogenic Fluid via the regulation of both by the Central Control and Coordination Unit 91, which has computerized formulas and receives information about changing temperature and pressures within the Power Chamber via Information Wires 96, from temperature gages 98, and pressure gages 97. Additional information can be gathered and sent to the Central Control 91 as needed to keep desired efficiencies at optimum levels.

It is not absolutely necessary but is preferred to keep a working minimum pressure in the Power Chamber at all times. This maintenance of working pressure assists the apparatus to deliver rapid response time of pressure delivery (say for vehicular applications), and also may assist in the more complete burning of the heat producing fuel which we want to get at as close to 100% as possible. One great feature of the power chamber is that it endeavors to use ALL OF THE HEAT CREATED. (Unlike the internal combustion engine which must dissipate or waste up to 78% of the heat created.) That's why the chamber 80 is highly Thermally Insulated 82.

The working pressure is held within the Power Chamber 80, by the sealed Working Pressure Release Door which has seals and is set to not open until a certain pressure threshold is passed. Then a Pressure Release Regulator 101 allows the door to open and allow the excess built up pressure to pass down the Pressure Delivery Channel 104 and on to one of the many different systems which may be used in conjunction with the Hybrid/Cryo Pressure Chamber to “harvest” and utilize that excess pressure to do work. There may or may not be a transmission utilized in particular applications to gear up or gear down rotational or other useful power as desired. When the representative “Accelerator Pedal” 93 is released or throttled down, then less or no further heat producing fuel is burned and less or no more cryogenic fuel is injected and eventually the pressure in the Power Chamber 80 will fall below the “Working Pressure” level and the Working Pressure Release Door in an open Position 100, will return to the position of “Working Pressure” Release Door in a closed Position 99.

The Working Pressure release door is shown as a door, but it could be any mechanism that performs the same function of allowing excess pressure to move into the Pressure Delivery Channel 104 to deliver pressure to do useful work. The apparatus is not limited to just use of a “door”.

The fuel tank of the heat producing fuel 71, has a filler port 72, and a pressure release valve 73 to avoid dangerous excess pressure build-up within the tank. If liquid air is utilized, then there must be some kind of a mixing mechanism not shown that keeps the liquid air and the liquid nitrogen from separating which would create a problem if all the oxygen was siphoned off 1^{st} and then no oxygen was available for heat fuel combustion. If only liquid Nitrogen is stored in the Cryogen Tank as is potential in Figure IV′ or there are two tanks for cryogens, as in Figure V, then a mixer in the Cryogen fuel tank is unnecessary. The Liquid Cryogen Tank 84, has a filler port and cap 85, and a pressure relief valve 86, to vent excess unwanted pressure and avoid dangerous excess pressure build-up within the tank. The Cryogen Liquid Air Fuel Tank 84 and the cryogen Fuel Supply Lines 89 and the pump 87 and the valve 88 all have technological insulation designed for cryogenic systems that does not allow unwanted heat into the system which would cause expansion before it is desired. This is usually accomplished within the cryogenic industry by maintaining a vacuum jacket around the tank or other object that only allows super minimum amounts of heat transfer.

One potential way to create pressure a desired amount of pressure for injection in the Cryogen Fuel Supply Line 89, rather then to do it with a pump 87, could be to apply a very small regulated amount of heat (say with an electric wire) to expand a very small amount of cryogenic fuel within the lines.

There may be the inclusion of various kinds of turbulence creating forms 103 and shapes, as represented in Figures II & V, to help facilitate the more complete mixing in the Chamber and hence the more efficient and rapid heat transfer rates.

I claim:

1. a substantially enclosed Power Mixing Chamber that rapidly and efficiently mixes heat produced by burning one fuel from one separate storage container with injected liquid cryogen fluid coming from another separate storage container,
said mixing causing rapid expansion of the cryogenic fluid creating excess pressure within that chamber;
said excess pressure expands in all directions within the chamber and also expands into a pressure delivery channel and past a door or equivalent that opens when a certain set threshold of pressure is surpassed;
said open door or equivalent being the only means by which excess pressure can escape from the power chamber;
said excess pressure that is then sent out from the pressure delivery channel and can be utilized for motive power or other useful work in conjunction with a wide variety of existing secondary apparatuses when connected in a sealed manner to the pressure delivery channel in such a manner that does not allow the wasteful loss of utilizable air pressure;
said power chamber which has a burner assembly with igniter which is sealed within the chamber and fed fuel to be combusted from a fuel feed line that comes from a fuel storage container outside of the chamber;
said power chamber which has cryogenic fluid injector(s) sealed within the chamber and are fed cryogenic fluid from fuel feed lines that are connected to a cryogenic liquid storage means for receiving and storing a specified amount of a cryogenic liquid therein.

2. The apparatus of claim 1. wherein the rapid and efficient mixing action inside of the power chamber is assisted by pressurized cryogenic fluid injectors with spray nozzles that atomize and also directionally send the injected cryogenic fluid towards the heat source within the chamber.

3. The apparatus of claim 1 that solves the major problems of icing up while utilizing cryogenic fluid for expansion power that were found with prior art heat exchangers because it does not utilize ambient moisture containing air but rather moisture less heat producing fuel and cryogenic fluids that have had any water moisture removed.

4. The apparatus of claim 1 that has throttling means for directing greater or lesser utilizable pressure creation in the power chamber via communication means with a Central Control and Coordination unit that has communication means with temperature and pressure gages that read conditions inside the Power Chamber and also has communication means with the inline pressure regulators and inline valves on both fuel feed lines so that a proper and efficient mixture of heat and liquid cryogen can be regulated and maintained within the Power Chamber.

5. The Power Chamber and Pressure Delivery Channel of claim 1. that can be fabricated of many different kinds of materials depending on the maximum working pressure desired per the particular power use application; also that can be made in any size from small to very large depending on the application use; and finally can be fabricated in any number of varying shapes that can accomplish the desired task of complete and efficient mixing of claims 1. and 2.

6. Air turbulence creating forms (103), placed within the container and attached to the walls as part of the walls to assist in implementing the desired task of complete and efficient mixing of claims 1. and 2.

7. An elongated or extended or convoluted Pressure Delivery Channel that enhance longer mixing times and assists in implementing the desired task of complete and efficient mixing of claims 1. and 2.

8. The completely separately enclosed heat producing fuel burner assembly and continuous Convoluted heat Transfer Pipe (as shown in Figure IV), which is enclosed within the Power Chamber and exits to an exhaust pipe direct to the atmosphere before it hits the “Working Pressure Release Door”; said assemble drawing in ambient temperature air with the water content filtered out as much as is practical;

9. Said burner assembly of claim 8 allowing the use of liquid Nitrogen only as the Cryogenic fluid if desired because combustion air is supplied from outside.

10. A differing Power Chamber (as shown in Figure V) that differs by having three separate fuel tanks; One tank for supplying heat producing fuel and two (2) cryogenic fuel tanks. One Cryogenic Fuel Tank supplying Liquid Nitrogen to the spray injectors and one Cryogenic Fuel Tank supplying Liquid Oxygen directly to the burner location. Said liquid oxygen is partially expanded just before it gets to the burner location to assist with more workable combustion use. Said expansion mans could be by electric warmer connected to or close to the Oxygen fuel line and supplied with its warming energy by onboard batteries and/or ultra-capacitor energy storage.

11. Said batteries and/or ultra capacitors could be recharged by part of the energy created by the power chamber and/or by regenerative breaking of a vehicle powered by the power chamber.
